(19) United States
(12) Patent Application Publication
(10) Pub. No.: US 2025/0298650 A1
(43) Pub. Date: Sep. 25, 2025

(54) WATCHDOG DAEMONS FOR SELF-RECOVERING HYPERVISORS

(71) Applicant: Oracle International Corporation, Redwood Shores, CA (US)

(72) Inventors: Shouyi Zhang, Seattle, WA (US); Ashley Valent, Seattle, WA (US); Jinzhu Deng, Seattle, WA (US)

(73) Assignee: Oracle International Corporation, Redwood Shores, CA (US)

(21) Appl. No.: 18/611,885

(22) Filed: Mar. 21, 2024

(51) Int. Cl. G06F 9/455

(52) U.S. Cl. CPC G06F 9/45558; G06F 2009/45575; G06F 2009/45591; G06F 2009/45595

(57) ABSTRACT

Techniques discussed herein relate to enabling a hypervisor to self-recover. In particular, a watchdog daemon may be executed at the hypervisor to perform periodic write disk checks of the boot volume associated with the hypervisor. Suppose an attempt to write to disk fails, e.g., an Error Input/Output (EIO) or Error Read Only File System (EROFS) return code is received. In that case, the daemon may determine that the boot volume is in read-only mode, post metrics to one or more logging services to indicate that the daemon has detected a read-only boot volume and reboot the respective hypervisor.

### BACKGROUND

Virtualization has become common place in multi-tenant clouds. By running multiple virtual machines (VMs) atop a hypervisor, the efficiency of a server machine can be maximized. During large-scale events (LSEs) in which a wide-spread outage is experienced, there may be numerous hypervisors that are unable to recover on their own. For hypervisors that lack self-healing capabilities, manual repair becomes necessary. Manual repairs result in additional downtime for cloud customers. Hypervisors may sometimes remain unresponsive even after dependencies, such as network and block storage, have been restored.

### BRIEF SUMMARY

Techniques are provided to enable the hypervisor to self-recover. The hypervisor's boot volume becoming read-only is a reason for the hypervisor's inability to self-recover and necessitate a manual reboot. To enable the hypervisor to self-recover from a read-only boot volume, a watchdog daemon may be deployed to monitor the hypervisor's boot volume. When the watchdog daemon detects that the boot volume associated with a hypervisor is in read-only mode, it may initiate reboot operations of the hypervisor. Various embodiments are described herein, including methods, systems, non-transitory computer-readable storage media storing programs, code, or instructions executable by one or more processors, and the like.

Embodiments of the present disclosure relate to techniques for performing an automated region build (e.g., bootstrapping (e.g., provisioning and/or deploying) resources (e.g., infrastructure component, artifacts, etc.) for any suitable number of services within a region (e.g., a geographical location associated with one or more data centers)).

At least one embodiment is directed to a method for monitoring the boot volume of a respective hypervisor. The method may comprise monitoring by a computing process executing at a host machine, a boot volume associated with a hypervisor. In some embodiments, the computing process may be deployed to the host machine as part of the hypervisor. The method may further comprise executing, by the computing process, one or more write requests to the boot volume associated with the hypervisor. The method may further comprise detecting, by the computing process, that the boot volume is operating in a read-only mode based at least in part on receiving one or more error codes. In some embodiments, the one or more error codes may be received in response to at least one of the one or more write requests. The method may further comprise verifying, by the computing process, that the boot volume associated with the hypervisor is operating in the read-only mode. In some embodiments, the method may comprise executing, by the computing process, operations for rebooting the hypervisor. The operations for rebooting the hypervisor may be executed in response to verifying that the boot volume associated with the hypervisor is operating in the read-only mode. Rebooting the hypervisor may make the boot volume writable.

In some embodiments, the one or more error codes may comprise at least one of 1) an Error—Input/Output (EIO) error code or 2) an Error—Read-Only File System (EROFS) error code. The write operations to the boot volume are performed to verify if the boot volume is in read-only mode. If the write operation returns EIO or EROFS, the boot volume may be in read-only mode.

The computing process may be a first computing process executing at a first host machine and separate from a second computing process executing at a second host machine. In some embodiments, the second computing process may be configured to monitor a corresponding boot volume of a respective hypervisor executing at the second host machine.

In some embodiments, the method may include transmitting, by the computing process to at least one logging service, logging data indicating the boot volume associated with the hypervisor is operating in the read-only mode. The logging data may be transmitted in response to verifying that the boot volume associated with the hypervisor is operating in the read-only mode. In some embodiments, the logging data is transmitted utilizing Domain Name Server (DNS) data, a Transport Layer Security (TLS) certificate, and a Public Key Infrastructure (PKI) certificate that are stored in the local memory of the host machine.

In some embodiments, the method may comprise verifying that the boot volume associated with the hypervisor is operating in the read-only mode. By way of example, the computing process may verify that the filesystem is in the read-only mode based at least in part on one or more error codes received in response to the write requests. In one example, the computing process may verify that the filesystem is in the ready-only mode based at least in part on receiving a second error code to receiving a first error code in response to two consecutive write requests. Verifying that the boot volume associated with the hypervisor is operating in the read-only mode may further comprise transmitting, by the computing process (e.g., to a baseboard management controller of the host machine), one or more console messages indicating that the boot volume associated with the hypervisor is operating in the read-only mode. In some embodiments, the baseboard management controller persists the one or more console messages in local memory at the host machine. The local memory may include local storage at the host machine, e.g., a hard drive.

In some embodiments, executing the operations for rebooting the hypervisor causes the hypervisor to enter a wait-for-recovery mode, during which a boot loop is executed. While executing the boot loop, the hypervisor may wait for a network dependency on the boot volume to be met prior to attempting to boot from the boot volume. In some embodiments, the boot volume that is associated with the hypervisor is remote with respect to the host machine and accessible via one or more networks.

In some embodiments, a watchdog daemon associated with a hypervisor of a computing device is disclosed. In some embodiments, the watchdog daemon may have been deployed to the computing device as part of the hypervisor. The computing device may comprise one or more processors and one or more memories storing computer-executable instructions that, when executed by the one or more processors, cause the watchdog daemon to perform operations. The operations may include transmitting, via a network, a first write request corresponding to a boot volume associated with the hypervisor of the computing device. The operations may comprise detecting a first error code corresponding to the first write request, the first error code indicating that the boot volume associated with the hypervisor is operating in a read-only mode. The operations may comprise transmitting a second write request corresponding to the boot volume associated with the hypervisor of the computing device. In some embodiments, the second write request may be transmitted in response to detecting the first error code. The operations may comprise executing one or more operations associated with rebooting the hypervisor. In some embodiments, the one or more operations associated with rebooting the hypervisor may be executed in response to detecting at least the first error code (e.g., the first error code, the first error code and the second error code).

In some embodiments, the watchdog daemon operates as a background process at the computing device. Execution of the watchdog daemon may be initiated by a system manager of an operating system of the computing device.

In some embodiments, the watchdog daemon is configured to detect, based at least in part on detecting the first error code, at least one of: expiration of a Small Computer System Interface (SCSI) command timer, expiration of an Internet Small Computer System Interface (iSCSI) replacement timer, or an iSCSI session logout.

In some embodiments, a number of tasks, memory usage, and disk storage corresponding to the watchdog daemon is limited.

In some embodiments, the watchdog daemon is restricted from rebooting the hypervisor unless the hypervisor has been executing for a period of time that exceeds a threshold period of time.

In some embodiments, a non-transitory computer-readable medium is disclosed. The non-transitory computer-readable medium may comprise one or more memories storing computer-executable instructions corresponding to a watchdog daemon that, when executed by one or more processors of a computing device, causes the watchdog daemon to perform operations. The operations may include monitoring access to a boot volume associated with a hypervisor executing at the computing device. The operations may include transmitting, via one or more networks, periodic requests to the boot volume associated with the hypervisor. The operations may include receiving a response to a request of the periodic requests. The response may indicate that the boot volume associated with the hypervisor is in a read-only mode. The operations may include performing one or more remedial actions based at least in part on receiving the response indicating that the boot volume associated with the hypervisor is in the read-only mode.

In some embodiments, the one or more remedial actions comprise transmitting logging data to one or more logging services. Transmitting the logging data to the one or more logging services may cause a status corresponding to the boot volume to be presented at a user interface. The status may indicate the boot volume is operating in the read-only mode.

In some embodiments, the operations may further comprise receiving a second response to a second request of the periodic requests. The second response may indicate that the boot volume associated with the hypervisor is in a read-only mode. The one or more remedial actions may be performed further based at least in part on receiving the second response indicating that the boot volume associated with the hypervisor is in the read-only mode.

In some embodiments, the operations may further comprise identifying a time at which the hypervisor was last booted and, responsive to determining that a threshold time has elapsed since the time at which the hypervisor was last booted, rebooting the hypervisor as part of performing the one or more remedial actions.

In some embodiments, the operations performed by the watchdog daemon may further comprise printing a message to a console prior to rebooting the hypervisor.

In some embodiments, the first response may comprise an input/output error or a read-only filesystem error. The input/output error or the read-only filesystem error may provide an indication that the boot volume associated with the hypervisor is in the read-only mode.

In some embodiments, the operations further comprise transmitting one or more metrics to one or more logging services prior to rebooting the hypervisor.

### BRIEF DESCRIPTION OF THE DRAWINGS

FIG. 1 illustrates a block diagram illustrating a cloud computing environment for implementing the present disclosure, according to at least one embodiment.

FIG. 2 is a block diagram illustrating an example method utilizing a watchdog daemon for detecting and recovering from hypervisor unresponsiveness, according to at least one embodiment.

FIG. 3 illustrates an example use case in which a watchdog daemon detects that a hypervisor's boot volume has become read-only, according to at least one embodiment.

FIG. 4 illustrates another example use case in which a watchdog daemon detects that a hypervisor's boot volume has become read-only, according to at least one embodiment.

FIG. 5 illustrates an example use case in which a boot volume recovers from a network outage, according to at least one embodiment.

FIG. 6 illustrates yet another example use case in which a watchdog daemon detects that a hypervisor's boot volume has become read-only, according to at least one embodiment.

FIG. 7 illustrates an example use case in which a block storage deployment is performed, according to at least one embodiment.

FIG. 8 is a block diagram depicting an example graphical interface of a logging service, according to at least one embodiment.

FIG. 9 is a block diagram illustrating an example method for detecting hypervisor unresponsiveness in accordance with at least one embodiment.

FIG. 10 is a block diagram illustrating one pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating an example computer system according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

### INTRODUCTION

An outage in a cloud computing system may refer to a situation where a critical component or service on which other components, services, or systems depend becomes unavailable or fails. The outage may include hardware components, software services, network connections, or external providers. An outage may disrupt the normal functioning of the entire system, leading to potential service interruptions, data loss, or degraded performance.

An outage may cause the hypervisor's boot volume to become read-only. While the hypervisor's boot volume is read-only, the hypervisor may not be able to self-recover. Outages that trigger read-only boot volumes may cause system unavailability, data integrity risks, and the inability to apply updates or patches or perform diagnostics or troubleshooting. Conventionally, restoring write access to the boot volume required a manual reboot of the hypervisor. However, manual reboots may cause excessive delay with respect to returning the system to a fully operational state. Embodiments described herein address these and other problems, individually and collectively.

The disclosed techniques utilize a computer process, e.g., a watchdog daemon, to monitor the hypervisor's boot volume to enable hypervisors to recover from outages that caused the boot volume to transition to a read-only mode. The watchdog daemon may initiate a reboot of the hypervisor based on detecting that the boot volume has transitioned to read-only mode. Following the reboot initiation, the hypervisor may enter a “wait-for-recovery” mode. For example, the “wait-for-recovery” mode may be implemented by an enhanced pre-boot execution environment (PXE) boot loop to wait for dependency recovery. A watchdog daemon may be deployed with each hypervisor (e.g., as part of the hypervisor's image) to locally identify situations in which a corresponding hypervisor loses write access to its boot volume (e.g., a boot volume provided via block storage and accessible via one or more networks).

Some of legacy solutions were not configured to detect particular errors (e.g., EIO, EROFS, etc.), which caused read-only boot volumes to be missed. During an outage (e.g., a Large Scale Event that affects a large number of computing components), logging may not be available because files were needed from the boot volume, which was not available due to the outage. To address some of these deficiencies, data assets may be stored in the local memory of the host machine (e.g., local memory such as hard drive space assigned to a hypervisor operating at the host machine) to enable the watchdog daemon to perform logging and to reduce the typical dependencies usually needed for logging data in the system. A watchdog daemon may also be configured to print console messages to a baseboard management controller in order to persist the data after hypervisor reboot when such data would otherwise be lost in most legacy solution implementations. The data that was logged and/or persisted locally at the host device may include any suitable data related to detecting the read-only state of a boot volume. In some embodiments, the resource consumption of the watchdog daemon is limited to keep the daemon from exhausting system resources.

### Architecture

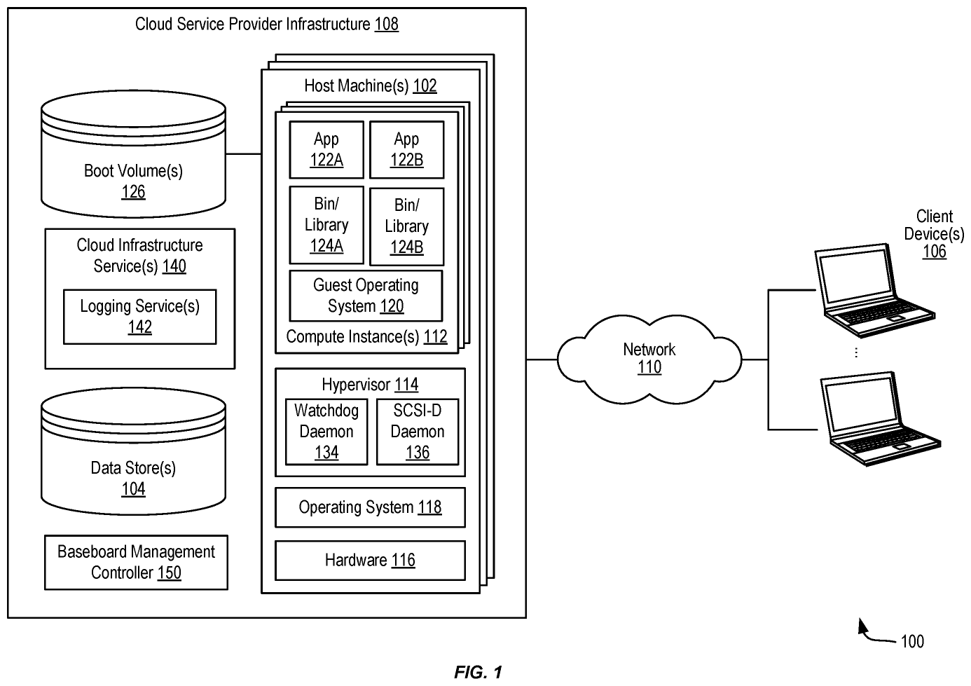

FIG. 1 illustrates a block diagram illustrating a cloud computing environment 100 for implementing the present disclosure, according to at least one embodiment. In some embodiments, the cloud computing environment 100 includes any suitable number of one or more host machines (e.g., host machine(s) 102) and one or more data store(s) 104 for providing to one or more client device(s) 106 access to cloud service provider infrastructure (CSPI) (e.g., CSPI 108) via a public network (e.g., network 110, the Internet). The CSPI 108 may be an Infrastructure-as-a-Service (IaaS) platform having a combination of hardware and software configured to carry out aspects of the present disclosure. Each of the host machine(s) 102 may execute one or more virtualized components. By way of example, each of the host machine(s) 102 may correspond to a physical device on which various compute instances (e.g., compute instance(s) 112) may be hosted. Compute instance(s) 112 is intended to be an example of virtual machine instances, referred to herein as “VMs.”

One or more of the host machine(s) 102 may execute a hypervisor (e.g., hypervisor 114) that creates and manages a virtualized environment. A hypervisor (e.g., hypervisor 114) may be run on a single physical server's hardware (e.g., hardware 116) that is configured to run operating system 118. Hypervisor 114 may be configured to create and manage any suitable number of compute instance(s) 112. Each of the compute instance(s) 112 may be an example of a virtual machine. A “virtual machine” refers to a compute resource that is a virtualization or emulation of a physical computer system. Compute instance(s) 112 may be run on a single physical server's hardware (e.g., hardware 116) that is configured to run operating system 118. The hypervisor 114 may be configured to ensure that each virtual machine (VM) (e.g., compute instance(s) 112) is isolated from all other VMs and that each VM is configured with its own operating system and kernel (herein referred to as a “guest operating system”). Guest operating system 120 may represent an example operating system and kernel. The hypervisor 114 may enable the physical computing resources of a host machine (e.g., hardware 116, including compute, memory, and networking resources) to be shared between the compute instance(s) 112 executed by the host machine.

Utilizing virtual machines (e.g., compute instance(s) 112) enables applications (e.g., applications 122A and 122B) to be isolated between VMs and provides a level of security as the information of one application cannot be freely accessed by another application. As depicted, each compute instance(s) 112 depicts an example of a full machine running all the components needed (e.g., applications 122A and 122B, bins/libraries 124A and 124B, etc.), including its own operating system (e.g., guest operating system 120), on top of the virtualized hardware. Each compute instance running on hypervisor 114 provides logical isolation in which no compute instance shares memory space with or awareness of other compute instances of the host machine.

In some embodiments, the hypervisor 114 and its associated boot volume(s) 126 may be connected through a small computer system interface (SCSI) or Internet-based SCSI (iSCSI). The SCSI or iSCSI may include a set of standard protocols used for physically connecting and transferring data between components of the CSPI 108.

The hypervisor 114 may be deployed with or subsequently configured with a SCSI device (SCSI-D) daemon 136. SCSI-D daemon 136 may be an example compute agent or process that executes at a host machine and is configured to monitor and manage SCSI or iSCSI connection between hypervisor 114 and its associated boot volume(s) 126.

In some embodiments, a boot volume may be encrypted by default. The boot volume(s) 126 may be remote with respect to the host machine(s) 102 and accessible via one or more networks (not depicted) of CSPI 108. When a compute instance is launched using an image, a boot volume for the compute instance may be created and added to boot volume(s) 126. The boot volume may be associated with the compute instance until the instance is terminated. When the compute instance is terminated, the boot volume and its data may be preserved. In some cases, a boot volume may be used to launch a new compute instance.

The hypervisor 114 may be deployed with or subsequently configured with watchdog daemon 134. Watchdog daemon 134 may be an example compute agent or process that executes at a host machine and is configured to perform periodic write disk checks to a boot volume with which the hypervisor 114 is associated (e.g., one of boot volume(s) 126). A “boot volume” refers to a storage container (e.g., a block volume, a detachable boot volume device, etc.) that may contain the image used to boot a resource (e.g., a hypervisor, each of compute instance(s) 112, etc.).

Watchdog daemon 134 may be a Linux system-managed service. In some instances, each hypervisor may be isolated and may have a watchdog daemon running on it. In some embodiments, the watchdog daemon 134 may be installed at the host machine(s) 102, separate from the hypervisor 114. Watchdog daemon 134 may perform local operations at the host machine(s) 102 based on detecting a read-only boot volume associated with the local hypervisor.

In some embodiments, watchdog daemon 134 may be deployed as part of the hypervisor. Conventional centralized implementations may be impacted by the network dependencies due to their utilization of network-based boot volume health monitoring. The disclosed techniques that include locally executing watchdog daemon 134 at the host machine(s) 102 may alleviate the system from such network dependencies, making the detection and remedy of read-only boot volumes more reliable.

Watchdog daemon 134 may include or otherwise be communicatively connected to one or more logging service(s) 142. Logging service(s) 142 may be provided by cloud infrastructure service(s) 140. Watchdog daemon 134 may transmit logging data to one or more logging service(s) 142. This data may include data that is associated with hypervisor 114 and/or data corresponding to an event that is associated with hypervisor 114. Detecting an event that is associated with a hypervisor may include detecting that a boot volume (e.g., one of boot volume(s) 126) that is associated with hypervisor 114 is in read-only mode and/or an attempt has been made to reboot boot volume(s) 126 associated with the hypervisor (e.g., the hypervisor 114 is executing a boot loop). 114. The logging data may include any suitable combination of an error type, a time, a description, diagnostics associated with a detected error, or the like.

In some embodiments, the cloud computing environment 100 may include a Baseboard Management Controller (BMC) 150. BMC 150 may monitor system status, handle system errors, retrieve hardware inventory information, or track user activity. In some embodiments, watchdog daemon 134 may print a console message, and the BMC 150 may store the console message as BMC data. The BMC 150 may store/persist console messages locally on the device hosting the hypervisor. In one example, the console message may be associated with an event (e.g., detecting that the boot volume(s) 126 associated with hypervisor 114 is read-only).

In some embodiments, the cloud computing environment 100 may include or otherwise be communicatively attached to one or more data stores (e.g., data store(s) 104, block storage, object storage, etc.) that may include any suitable combination of computing devices configured to store and organize a collection of data. In some embodiments, the data store(s) 104) may store images (and data related thereto) that have been registered for use within the cloud computing environment 100.

An image may be an example template of a hard drive and may be used to install the operating system and other software for a compute instance. Users can create compute instances as needed to meet their compute and application requirements and the infrastructure configurations (or shapes) of the hardware running the images, for example, on the host machine(s) 102. After an instance is created, the user can access the compute instance securely from their client device(s) 106, restart it, attach and detach volumes, and terminate it when done with it.

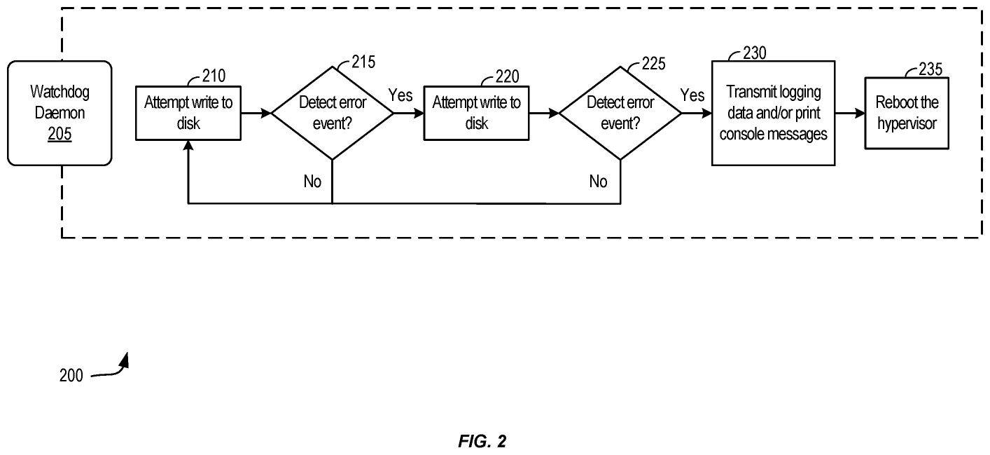

FIG. 2 is a block diagram illustrating an example method 200 utilizing watchdog daemon 205 for detecting and recovering from hypervisor unresponsiveness, according to at least one embodiment. Watchdog daemon 205 may be an example of watchdog daemon 134 in FIG. 1.

Watchdog daemon 205 may be a system-managed service. In some embodiments, watchdog daemon 205 may be associated with a memory limit (e.g., a memory limit of 0.5, 1, 2, or 4 gigabytes (GB)), a task limit (e.g., a task limit of 10, 20, 50, 100, etc.), or a disk limit (e.g., a disk limit of 0.5, 1, 2, or 4 GB).

The method may begin at 210, where watchdog daemon 205 may attempt a write check. Attempting a write check may include transmitting to the hypervisor's boot volume or a service that manages the hypervisor's boot volume, a disk write request that requests data to be written to the hypervisor's boot volume, In some embodiments, the watchdog daemon 205 may be configured to attempt write checks according to a predefined schedule or periodicity or on demand.

At 215, watchdog daemon 205 may determine whether an error event has been detected. In some embodiments, determining whether an error event has been detected includes determining whether an error code from the hypervisor's boot volume was received in response to a write check. Determining whether an error event has been detected may include determining whether an error input/output (EIO) error code or an error read-only file system (EROFS) error code has been received in response to the write check. In some cases, receipt of EIO and EROFS error codes may be indicative of a read-only boot volume, while other error codes may not. In some embodiments, watchdog daemon 205 may detect (e.g., via the EIO and/or EROFS error codes) any suitable combination of an SCSI command timer expiration, an iSCSI replacement timer expiration, or an iSCSI session logout.

If watchdog daemon 205 determines that no error codes (or particular error codes such as the EIO and/or EROFS error codes) have been received in response to the previous write check, the method may return to 210 to continue performing periodic write checks.

Alternatively, if an error event is detected at 215 (e.g., the watchdog daemon 205 determines that an EIO or EROFS error code has been received in response to the write check performed at 210), the method may proceed to 220. Alternatively, in some embodiments, when an error event is detected at 215, the watchdog daemon 205 may determine that the boot volume is operating in a read-only mode, and method 200 may proceed to step 230.

At 220, watchdog daemon 205 may attempt a second write check. The second write check may be performed to verify that the hypervisor's boot volume is in read-only mode. The second write check may be used to ensure that the previously detected read-only state was not transitory and to ensure that reboots of the hypervisor are not needlessly performed. The second write check may include transmitting another disk wright request to the hypervisor's boot volume (or corresponding managing system, such as a block volume storage service of Cloud Infrastructure Service(s) 140 of FIG. 1). In some embodiments, the watchdog daemon 205 may be configured to transmit the second write check by/within a certain amount of time after transmitting the first write check. By way of example, watchdog daemon 205 may initiate a timer upon detecting the error event at 215. Expiration of the timer may trigger the transmission of the second write check. In some embodiments, the second write check may be transmitted regardless of the time at which the first write check was transmitted.

At 225, watchdog daemon 205 may determine whether an error event has been received in response to the most recently transmitted write check. As discussed above, the watchdog daemon 205 may detect an error event has occurred (e.g., indicating that the hypervisor's boot volume is in a read-only mode) based at least in part on determining that an error input/output (EIO) and/or an error read-only file system (EROFS) error code has been received.

If watchdog daemon 205 determines that no error codes (or particular error codes such as the EIO and/or EROFS error codes) have been received in response to the previous write check, the method may return to 210 to continue performing periodic write checks.

In some embodiments, the watchdog daemon 205 may be configured to determine that the hypervisor's boot volume is in a read-only mode (and/or that the boot volume has been verified as being in a read-only mode) based at least in part on detecting any suitable combination of the error events at 215 and/or 225. In some embodiments, the watchdog daemon 205 may determine that the boot volume is operating in a read-only mode only after the (second) error event is detected at 225. If the watchdog daemon determines/verifies that the boot volume is in a read-only mode, the process may proceed to step 230.

At 230, based on detecting and/or verifying that the boot volume is operating in a read-only mode, watchdog daemon 205 may transmit logging data and/or print one or more console messages. In some embodiments, the data may be associated with the error event and may include any suitable combination of an event identifier, an identifier associated with the watchdog daemon 205, an identifier associated with the hypervisor, an identifying associated with the boot volume, a timestamp corresponding to a time at which the boot volume was determined to be operating in the read-only mode, the one or more error code(s) on which the read-only determination was based, corresponding times at which the one or more error code(s) were received, or any suitable data corresponding to the error event. In some embodiments, the data may be transmitted to logging service(s) 142 of FIG. 1. In some embodiments, the data may be transmitted to the Baseboard Management Controller (BMC) 150 of FIG. 1 and persisted in local memory. Although depicted as occurring prior to rebooting the hypervisor at 235, the operations performed at 230 may alternatively be executed subsequent to the operations performed at 235. In either case, the data may include an indication of whether watchdog daemon 134 attempted to reboot the hypervisor.

In embodiments in which watchdog daemon 205 transmits logging data to one or more logging services, the watchdog daemon 205 may use a monitoring software development kit (SDK) for the transmission. At least one logging service may be a lightweight service that provides a point-in-time view of service health, even during large scale events (e.g., outages that affect a large number of computing components). A lightweight logging service may have few dependencies, so it can survive incidents that may impact many core services.

In some embodiments, any suitable combination of domain name server (DNS) data, a transport layer security (TLS) certificate, and/or a public key infrastructure (PKI) certificate may be stored in the local memory of a device that hosts the hypervisor to enable transmitting and/or logging the data with the one or more logging services. In some embodiments, the DNS data, the TLS certificate, and/or the PKI certificate may be included in the hypervisor's image and stored in local memory during the deployment and/or installation of the hypervisor and/or watchdog daemon 134. In some cases, any suitable combination of the DNS data, the TLS certificate, and/or the PKI certificate may be deployed and/or otherwise stored in the memory of a corresponding host machine on which the hypervisor and watchdog daemon 134 execute at any suitable time and/or as part of a separate process to configured the watchdog daemon/host machine with data needed for successful transmissions and/or logging of data with the one or more logging services.

In some embodiments, watchdog daemon 205 may be configured to print a console message after detecting a read-only boot volume. Printing a console message may include transmitting data to be included in the console message to a baseboard management controller (BMC) (e.g., BMC 150 of FIG. 1). The data of the console message may be the same or different from the logging data discussed above. In some embodiments, the console message may include any suitable combination of the attributes of the logging data discussed above. In some embodiments, watchdog daemon 205 may print the console message before the hypervisor reboot. Transmitting data to the BMC may cause the data to be stored locally (e.g., as BMC data) and persisted in local memory (e.g., a portion of a local hard drive, local hard drive space dedicated and/or assigned to the hypervisor, etc.) at the device hosting the hypervisor.

At 235, watchdog daemon 205 may execute any suitable operations to cause a reboot of the hypervisor (e.g., hypervisor 114) based on determining that the boot volume associated with the hypervisor is in read-only mode. In some embodiments, watchdog daemon 205 may reboot the hypervisor at a preconfigured time after printing the console message and/or logging the data at 230. While waiting to reboot, watchdog daemon 205 may send one or more notifications to a user and/or the operator. The notification(s) may include any suitable data associated with the error event, the watchdog daemon 205, the hypervisor, the boot volume, the particular error codes detected/received, time(s) at which the error code(s) were received, a time at which the read-only mode of the boot volume was determined, or the like. The notification(s) may include an indication that watchdog daemon 205 plans to reboot the hypervisor and/or that the watchdog daemon 205 has executed operations to reboot the hypervisor. In some embodiments, watchdog daemon 205 may be restricted from rebooting the hypervisor unless the hypervisor has been running for longer than a predefined time period (e.g., 1 hour, 2 hours, a day, etc.).

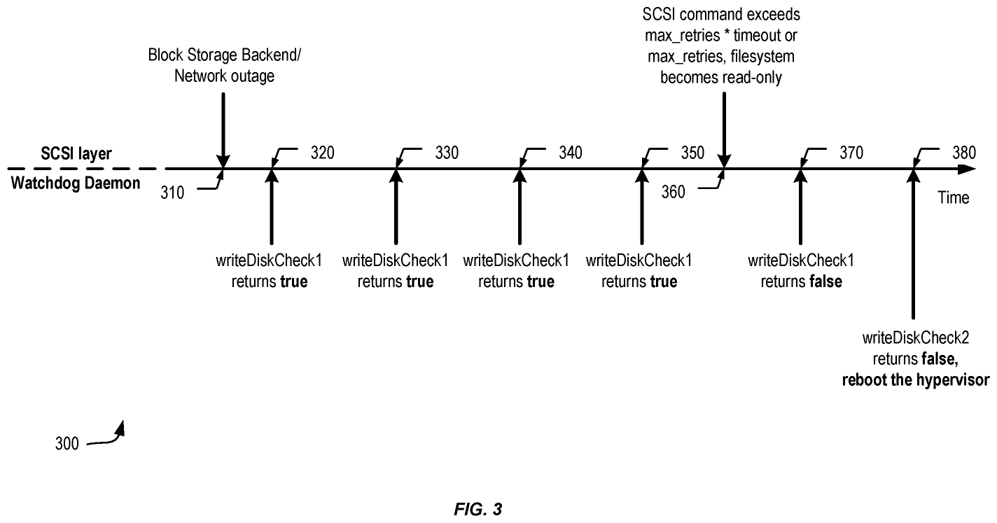

FIG. 3 illustrates an example use case 300 in which a watchdog daemon (e.g., watchdog daemon 134 of FIG. 1) detects that a hypervisor's boot volume (e.g., one of boot volume(s) 126 of FIG. 1) has become read-only, according to at least one embodiment.

At 310, a backend block storage outage and/or network outage occurs. The outage(s) may cause access to backend block storage (e.g., including boot volume(s) 126) to be limited and/or unavailable. A SCSI layer component may detect the outage. However, the boot volume may not immediately become read-only. In other words, the boot volume may continue operating for a time in a mode that indicates that write requests will be allowed, although write requests may be unsuccessful during that time due to the outage experienced at 310.

At 360, the boot volume may be transitioned to operate in a read-only mode (e.g., a mode during which write requests will be denied). The file system may become read-only when the number of rejected/denied SCSI commands exceeds a threshold. The threshold may be associated with one or more SCSI parameters. For example, the threshold may be based on a parameter that specifies a maximum number of retries. The parameter may be used to limit how many times the system attempts a write request to avoid needless processing. In some embodiments, the parameters may include a timeout value that identifies a time period (e.g., 100 minutes, 1 hour, etc.) that, upon expiring, triggers the system to transition the boot volume to a read-only mode. Any suitable trigger may be used to perform the transition. In some embodiments, the read-only mode of a boot volume may be based on both a time period and a maximum number of retries.

The watchdog daemon may perform one or more write disk checks (e.g., as part of a process in which the watchdog daemon performs periodic write checks and/or write checks according to a predefined schedule or periodicity). By way of example, the watchdog daemon may perform write checks at 320, 330, 340, and 350. Because the file system of the boot volume has not yet been transitioned to read-only, none of the write checks performed at 320-350 may return an error code (or at least not an error code such as an EIO or EROFS error code).

At 360, a triggering event may occur (e.g., a SCSI command threshold of a maximum number of retries has been breached, a timeout period has elapsed, or both) that causes the system to transition the boot volume to read-only.

At 370, the watchdog daemon may perform another periodic write check. Due to the transition of the boot volume to a read-only mode, an error code (e.g., an EIO error code or EROFS error code) may be received in response to the write check. As similarly discussed in connection with FIG. 2, receipt of a single error code (e.g., the error code received at 370) may cause the watchdog daemon to reboot the hypervisor. In some embodiments, the watchdog daemon may be configured to verify the status of the boot volume before rebooting the hypervisor to avoid unnecessary delays due to transient issues.

At 380, the watchdog daemon may perform another write check. A second error code may be received in response to the write check performed at 380. In some embodiments, if the watchdog daemon determines that a second EIO error code or EROFS error code has been received and/or that two consecutive write requests have resulted in the same or similar EIO/EROFS error code, the watchdog daemon may be configured to execute operations to reboot the hypervisor. These operations may be performed at any suitable time subsequent to detecting the read-only boot volume based on the write disk check performed at 380.

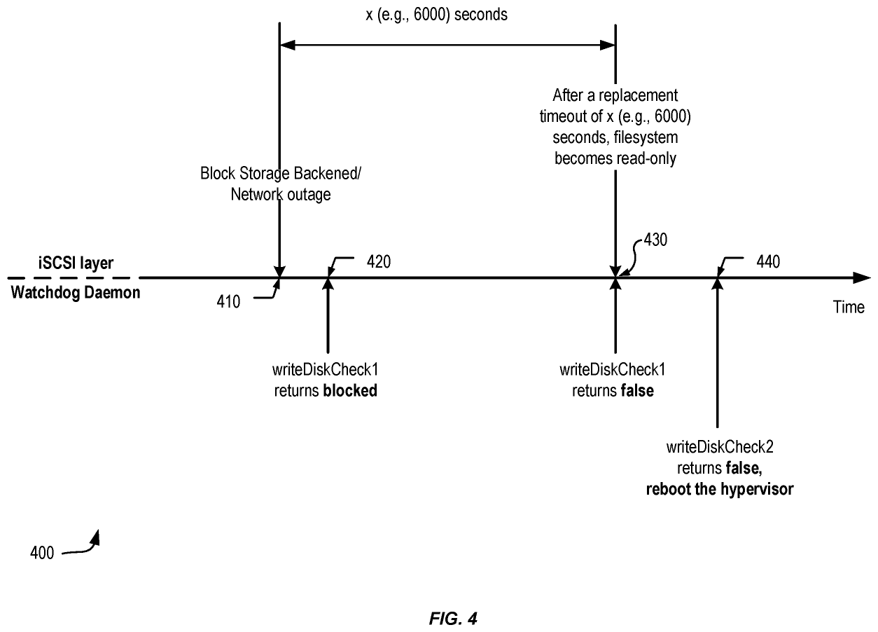

FIG. 4 illustrates another example use case 400 in which a watchdog daemon (e.g., watchdog daemon 134 of FIG. 1) detects that a hypervisor's boot volume has become read-only, according to at least one embodiment.

At 410, a network outage and/or backend block storage outage may occur, limiting access to a hypervisor's boot volume. The iSCSI layer may detect the outage and may initiate an iSCSI replacement timer. The system may use an iSCSI replacement timeout to identify a time period during which the iSCSI layer should wait for a time-out network path/session to reestablish itself. In some embodiments, the iSCSI layer may be configured to transition the boot volume to a read-only mode only after the iSCSI replacement timeout has expired.

At 420, prior to the expiration of the iSCSI replacement timeout, a watchdog daemon may attempt to perform a write check. However, the attempt may be blocked due to the lost network path resulting from the outage at 410. The write check may return a message indicating that the access is blocked. However, because the return message is not an EIO or EROFS, the watchdog daemon may not consider it a failed attempt.

At 430, the iSCSI layer may declare that the filesystem is read-only. The iSCSI layer may make the determination based on a replacement timeout. For example, the iSCSI layer may start a timer at 410 and upon expiration of the timer (e.g., 1000, 2000, 4000, 6000 seconds later, etc.). The iSCSI layer may mark the filesystem as read-only. This may include associating the boot volume with a label or other suitable data that indicates the boot volume is operating in a read-only mode.

Also, at 430 (or at some subsequent time), the watchdog daemon may attempt another write check. The write check may return an EIO or EROFS based on the filesystem (e.g., the boot volume) now operating in read-only mode.

As discussed above, the watchdog daemon may attempt a reboot of the hypervisor after the first error code is received in response to the write check, or the watchdog daemon may be configured to perform a second write check at 440 to verify that the boot volume is read-only (e.g., based on receiving two, potentially consecutive, error codes)

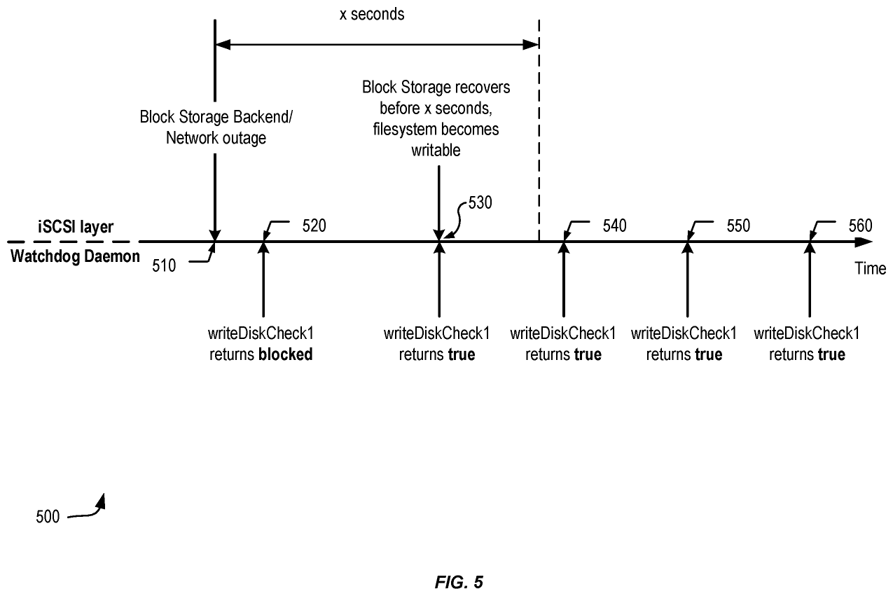

FIG. 5 illustrates an example use case 500 in which a boot volume (e.g., one of boot volume(s) 126 of FIG. 1) recovers from a network outage, according to at least one embodiment.

The situation and/or operations performed at 510 and 520 are similar to those discussed in connection with FIG. 4 at 410 and 420, respectively, and will not be discussed again for brevity.

At 530, before the expiration of the iSCSI replacement timeout, the block storage recovers (and/or the network outage is rectified), and the filesystem becomes writable. As a result, the write checks performed at 530, 540, 550, and 560 are successful (e.g., return “true” or at least return values that lack an EIO or EROFS error code). Since no error codes are received, the watchdog daemon may forgo triggering a reboot of the hypervisor.

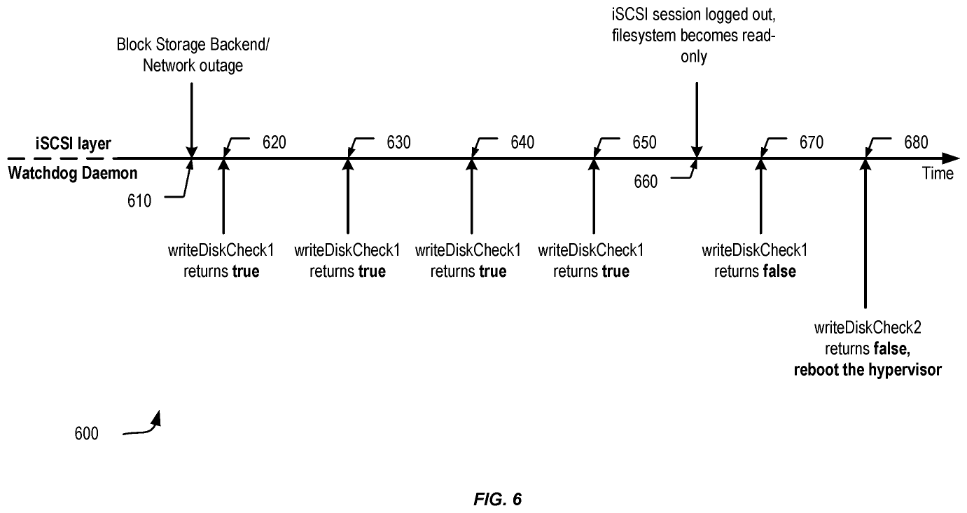

FIG. 6 illustrates yet another example use case 600 in which a watchdog daemon (e.g., watchdog daemon 134 of FIG. 1) detects that a hypervisor's boot volume has become read-only, according to at least one embodiment.

The situations and operations at 610-650 are similar to those discussed at 310-350 in connection with FIG. 3. The description of these operations and situations will not be repeated for brevity.

At 660, the iSCSI session may end (e.g., due to log out). As a result, the filesystem may be transitioned to read-only, and the hypervisor may write access to its boot volume (e.g., one of boot volume(s) 126 of FIG. 1) via the iSCSI layer.

The operations performed at 670 and 680 (e.g., to detect/verify boot volume read-only status and reboot the hypervisor) may be the same or similar to those depicted at 370 and 380 of FIG. 3 and will not be repeated herein for brevity.

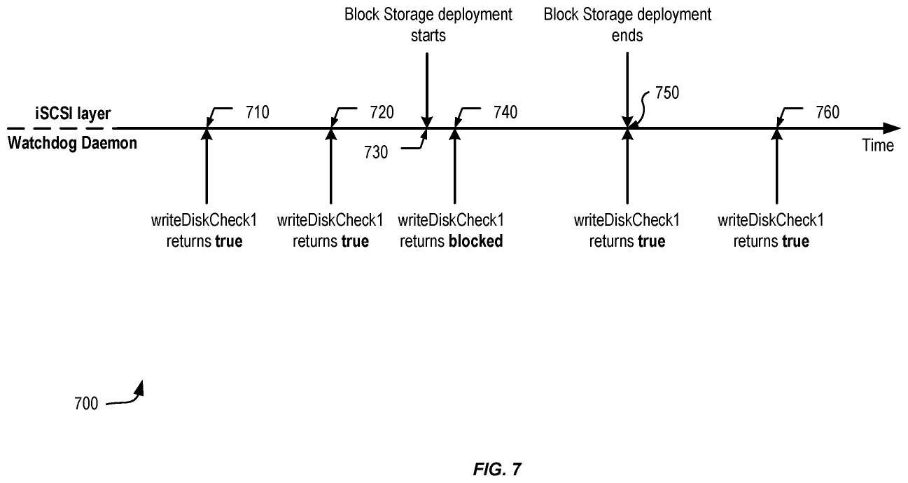

FIG. 7 illustrates an example use case 700 in which a block storage deployment is performed, according to at least one embodiment.

At 710 and 720, the write check by a watchdog daemon (e.g., watchdog daemon 134 of FIG. 1) may not return an error code because no block storage is deployed.

At 730, the block storage deployment starts. During the block storage deployment, the iSCSI session status is blocked. Therefore, the input/output (I/O) is blocked until the deployment is finished.

At 740, the write check of the watchdog daemon may return a blocked status since the block storage deployment has started but has not yet been finished. The block status is not an EIO or EROFS error code; therefore, the watchdog daemon may not consider the write check a failed attempt.

At 750, the block storage deployment ends, and write check attempts by watchdog daemon at 750 or 760 may be successful.

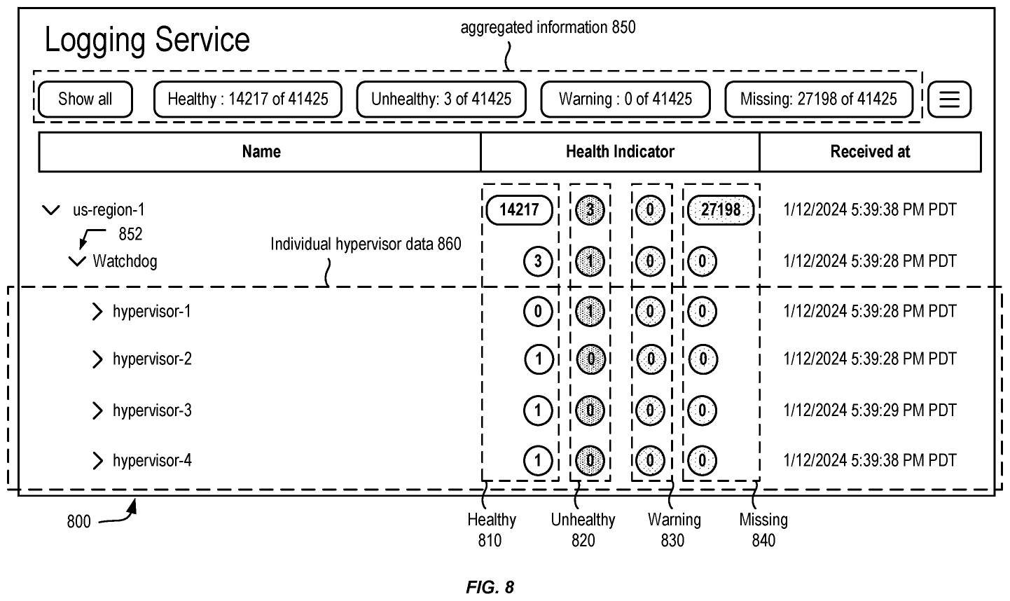

FIG. 8 is a block diagram depicting an example graphical interface 800 of a logging service, according to at least one embodiment.

In one example, the logging service may provide historical data, e.g., past events such as outages, reboots, or error messages. In another example, the logging service may provide a point-in-time view of service health. The graphical interface 800 is an example of a graphical interface of a logging service that provides a point-in-time view of service health.

The graphical interface 800 may include a section to display aggregated information 850. In some embodiments, the aggregated information 850 may indicate any suitable combination of a number of healthy hypervisors, a total number of hypervisors, a total number of unhealthy hypervisors, or the like. As depicted in FIG. 8, aggregated information 850 may include a total number of warnings and/or a total number of hypervisors for which health status is missing/unknown.

The graphical interface 800 may include information for each hypervisor. The entries on the healthy 810 column, unhealthy 820 column, warning 830 column, or missing 840 column may provide information for components of the CSPI 108. For example, the information associated with “us-region-1” indicates that, in a data center corresponding to “us-region-1,” there are 1427 healthy hypervisors, 3 unhealthy hypervisors, 27198 hypervisors for which status is missing/unknown, and no warnings have been received.

In some embodiments, the graphical interface 800 may provide individualized information for each hypervisor. For example, the entry of the healthy 810 column for hypervisor-2 has a value of ‘1’ and may indicate that the hypervisor-2 is a healthy hypervisor. The entry of the unhealthy 820 column for hypervisor-1 has a value of ‘1’ and may indicate that hypervisor-1 is an unhealthy hypervisor. The graphical interface 800 may also include a region that provides the date and time associated with the status of the hypervisors. For example, a region of the graphical interface 800 may include information that indicates that the hypervisor-3 status information was received on at 1/12/2024 5:39:29 PM PDT. In some embodiments, any suitable portion of the graphical interface 800 may be collapsed or expanded using interface elements similar to interface element 852. Interface element 852 may correspond to a toggle with which watchdog data may be collapsed (e.g., to hide individual hypervisor data 860) or expanded (e.g., to view the individual hypervisor data 860).

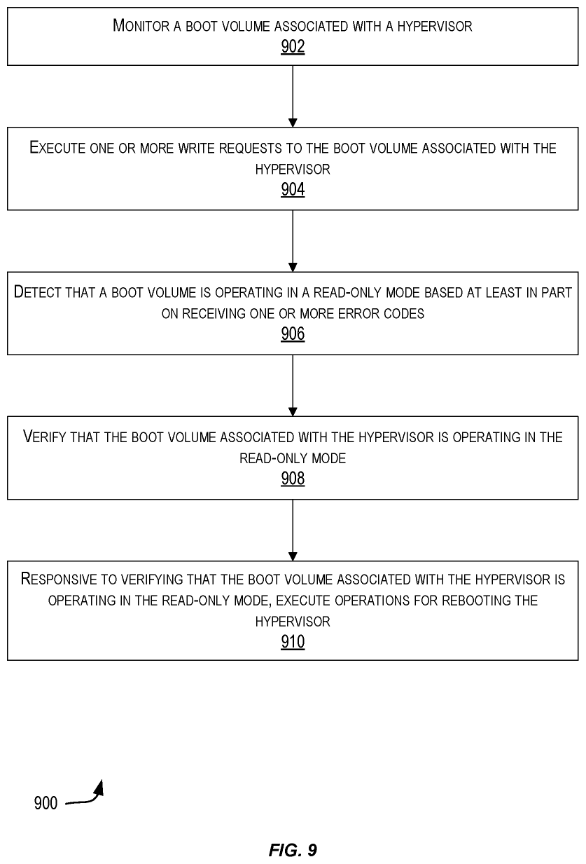

FIG. 9 is a block diagram illustrating an example method for detecting hypervisor unresponsiveness in accordance with at least one embodiment. Method 900 may be performed by a computing process or application of CSPI 108 of FIG. 1. By way of example, method 900 may be performed by watchdog daemon 134 of FIG. 1. In some embodiments, method 900 may include more or fewer steps than the number depicted in FIG. 9. It should be appreciated that the steps of method 900 may be performed in any suitable order.

Method 900 may begin at 902, where a boot volume (e.g., a boot volume of the boot volume(s) 126 of FIG. 1) associated with a hypervisor (e.g., hypervisor 114 of FIG. 1) may be monitored by a computing process (e.g., the watchdog daemon 134 of FIG. 1). The computing process may be execute at a host machine (e.g., one of host machine(s) 102 of FIG. 1). In some embodiments, the computing process may be deployed to the host machine as part of the hypervisor (e.g., as part of an image with which the hypervisor is deployed). A system manager of an operating system of the compute device (e.g., the guest operating system 120 of the compute instance(s) 112) may initiate the execution of the computing process at the host machine. The boot volume associated with the hypervisor may be remote with respect to the host machine. For example, the boot volume may not be physically part of the host machine. The boot volume may be accessible via one or more networks or network connections.

In some embodiments, a second computing process executing at a second host machine (e.g., a second host machine of the host machine(s) 102 of FIG. 1) may be configured to monitor a corresponding boot volume of a respective second hypervisor. The respective second hypervisor may be executed on the second host machine.

At 904, the computing process may execute a one or more write requests (e.g., the write checks performed at 310-380 of FIG. 3, 410-440 of FIG. 4, etc.). Executing the one or more of the write requests may include transmitting the write request to the boot volume associated with the hypervisor or to a resource manager that is configured to manage the boot volume. In some embodiments, the computing process may be configured to send write requests periodically or according to a predefined schedule.

At 906, the computing process may detect that the boot volume is in a read-only mode. The computing process may detect that the boot volume is operating in a read-only mode based at least in part on receiving one or more error codes. The computing process may receive one or more error codes in response to the write requests. For example, when the write request fails to write on the boot volume, the computing process may receive an error code in return. In some embodiments, the error code is an EIO. In other embodiments, the error code is an EROFS. In some embodiments, the computing process may receive multiple error codes, e.g., EIO and EROFS. The computing process may be configured to detect (e.g., via one or more error codes such as the EIO and/or EROFS, or another suitable error code) at least one of an expiration of an SCSI command timer, an expiration of an iSCSI replacement timer, or an iSCSI session logout.

At 908, the computing process may verify (and/or determine) that the boot volume associated with the hypervisor is operating in the read-only mode. The computing process may verify that the boot volume is in the read-only mode based at least in part on receiving the one or more error codes returned in response to the write requests. In one example, the computing process may verify that the boot volume is in the ready-only mode based at least in part on receiving two or more consecutive error codes. In another example, the computing process may verify that the boot volume is in the read-only mode based on information received or obtained from other components of the CSPI 108 (e.g., a SCSI-D daemon).

At 910, in response to verifying that the boot volume associated with the hypervisor is operating in the read-only mode, the computing process may execute operations for rebooting the hypervisor. In some embodiments, the operations for rebooting the hypervisor may cause the hypervisor to enter a wait-for-recovery mode. During the wait-for-recovery mode, a boot loop may be executed. The execution of the boot loop may cause the hypervisor to wait for a network dependency on the boot volume to be me prior to attempting to boot from the boot volume.

Other actions may be additionally or alternatively performed in response to verifying that the boot volume associated with the hypervisor is operating in the read-only mode. For example, in response to verifying that the boot volume associated with the hypervisor is operating in the read-only mode, the computing process may transmit logging data to a logging service. The logging data may indicate that the boot volume associated with the hypervisor is operating in the read-only mode. In some embodiments, the computing process may store the DNS, TLS certificate, or PKI certificate in the local memory of the host machine. The transmission of the logging data to the logging service may utilize the locally stored DNS, TLS certificate, or PKI certificate.

As another non-limiting example, in response to verifying that the boot volume associated with the hypervisor is operating in the read-only mode, the computing process may transmit one or more console messages to a Baseboard Management Controller (BMC) (e.g., BMC 150 in FIG. 1) of the host machine. The console messages may indicate that the boot volume associated with the hypervisor is operating in the read-only mode. The Baseboard Management Controller may persist one or more console messages in local memory at the host machine.

### Example IaaS Environments

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable the deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

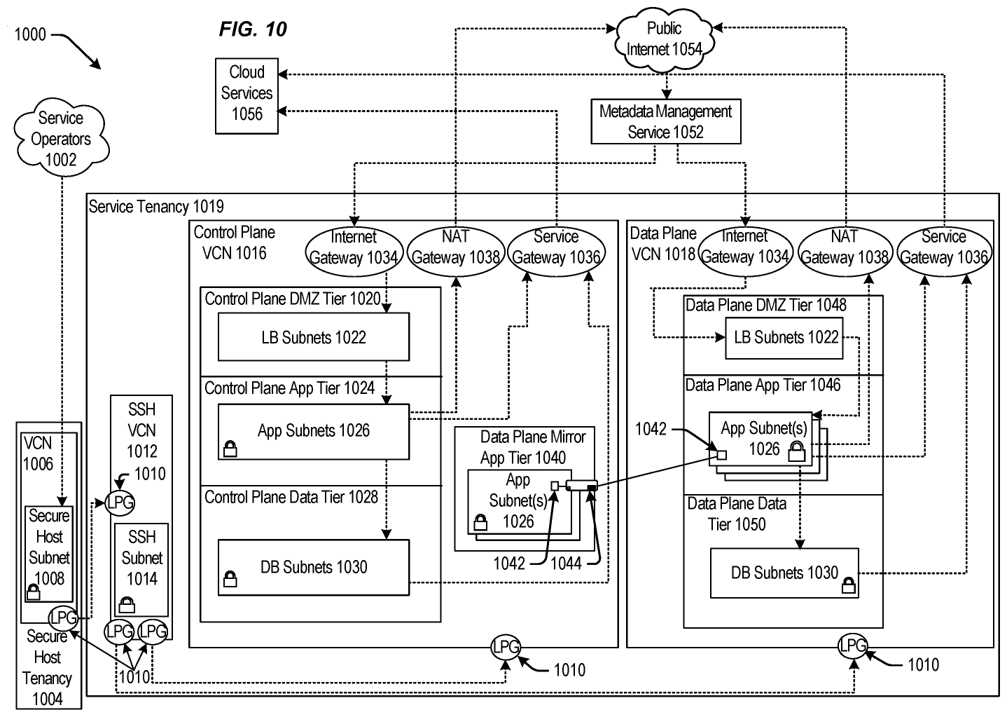

FIG. 10 is a block diagram 1000 illustrating an example pattern of an IaaS architecture, according to at least one embodiment. Service operators 1002 can be communicatively coupled to a secure host tenancy 1004 that can include a virtual cloud network (VCN) 1006 and a secure host subnet 1008. In some examples, the service operators 1002 may be using one or more client computing devices, which may be portable handheld devices (e.g., an iPhone®, cellular telephone, an iPad®, computing tablet, a personal digital assistant (PDA)) or wearable devices (e.g., a Google Glass® head-mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general-purpose personal computers including, by way of example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including, without limitation, the variety of GNU/Linux operating systems, such as Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1006 and/or the Internet.

The VCN 1006 can include a local peering gateway (LPG) 1010 that can be communicatively coupled to a secure shell (SSH) VCN 1012 via an LPG 1010 contained in the SSH VCN 1012. The SSH VCN 1012 can include an SSH subnet 1014, and the SSH VCN 1012 can be communicatively coupled to a control plane VCN 1016 via the LPG 1010 contained in the control plane VCN 1016. Also, the SSH VCN 1012 can be communicatively coupled to a data plane VCN 1018 via an LPG 1010. The control plane VCN 1016 and the data plane VCN 1018 can be contained in a service tenancy 1019 that can be owned and/or operated by the IaaS provider.

The control plane VCN 1016 can include a control plane demilitarized zone (DMZ) tier 1020 that acts as a perimeter network (e.g., portions of a corporate network between the corporate intranet and external networks). The DMZ-based servers may have restricted responsibilities and help keep breaches contained. Additionally, the DMZ tier 1020 can include one or more load balancer (LB) subnet(s) 1022, a control plane app tier 1024 that can include app subnet(s) 1026, a control plane data tier 1028 that can include database (DB) subnet(s) 1030 (e.g., frontend DB subnet(s) and/or backend DB subnet(s)). The LB subnet(s) 1022 contained in the control plane DMZ tier 1020 can be communicatively coupled to the app subnet(s) 1026 contained in the control plane app tier 1024 and an Internet gateway 1034 that can be contained in the control plane VCN 1016, and the app subnet(s) 1026 can be communicatively coupled to the DB subnet(s) 1030 contained in the control plane data tier 1028 and a service gateway 1036 and a network address translation (NAT) gateway 1038. The control plane VCN 1016 can include the service gateway 1036 and the NAT gateway 1038.

The control plane VCN 1016 can include a data plane mirror app tier 1040 that can include app subnet(s) 1026. The app subnet(s) 1026 contained in the data plane mirror app tier 1040 can include a virtual network interface controller (VNIC) 1042 that can execute a compute instance 1044. The compute instance 1044 can communicatively couple the app subnet(s) 1026 of the data plane mirror app tier 1040 to app subnet(s) 1026 that can be contained in a data plane app tier 1046.

The data plane VCN 1018 can include the data plane app tier 1046, a data plane DMZ tier 1048, and a data plane data tier 1050. The data plane DMZ tier 1048 can include LB subnet(s) 1022 that can be communicatively coupled to the app subnet(s) 1026 of the data plane app tier 1046 and the Internet gateway 1034 of the data plane VCN 1018. The app subnet(s) 1026 can be communicatively coupled to the service gateway 1036 of the data plane VCN 1018 and the NAT gateway 1038 of the data plane VCN 1018. The data plane data tier 1050 can also include the DB subnet(s) 1030 that can be communicatively coupled to the app subnet(s) 1026 of the data plane app tier 1046.

The Internet gateway 1034 of the control plane VCN 1016 and of the data plane VCN 1018 can be communicatively coupled to a metadata management service 1052 that can be communicatively coupled to public Internet 1054. Public Internet 1054 can be communicatively coupled to the NAT gateway 1038 of the control plane VCN 1016 and of the data plane VCN 1018. The service gateway 1036 of the control plane VCN 1016 and of the data plane VCN 1018 can be communicatively coupled to cloud services 1056.

In some examples, the service gateway 1036 of the control plane VCN 1016 or of the data plane VCN 1018 can make application programming interface (API) calls to cloud services 1056 without going through public Internet 1054. The API calls to cloud services 1056 from the service gateway 1036 can be one-way: the service gateway 1036 can make API calls to cloud services 1056, and cloud services 1056 can send requested data to the service gateway 1036. But, cloud services 1056 may not initiate API calls to the service gateway 1036.

In some examples, the secure host tenancy 1004 can be directly connected to the service tenancy 1019, which may be otherwise isolated. The secure host subnet 1008 can communicate with the SSH subnet 1014 through an LPG 1010 that may enable two-way communication over an otherwise isolated system. Connecting the secure host subnet 1008 to the SSH subnet 1014 may give the secure host subnet 1008 access to other entities within the service tenancy 1019.

The control plane VCN 1016 may allow users of the service tenancy 1019 to set up or otherwise provision desired resources. Desired resources provisioned in the control plane VCN 1016 may be deployed or otherwise used in the data plane VCN 1018. In some examples, the control plane VCN 1016 can be isolated from the data plane VCN 1018, and the data plane mirror app tier 1040 of the control plane VCN 1016 can communicate with the data plane app tier 1046 of the data plane VCN 1018 via VNICs 1042 that can be contained in the data plane mirror app tier 1040 and the data plane app tier 1046.

In some examples, users of the system, or customers, can make requests, for example, create, read, update, or delete (CRUD) operations, through public Internet 1054 that can communicate the requests to the metadata management service 1052. The metadata management service 1052 can communicate the request to the control plane VCN 1016 through the Internet gateway 1034. The request can be received by the LB subnet(s) 1022 contained in the control plane DMZ tier 1020. The LB subnet(s) 1022 may determine that the request is valid, and in response to this determination, the LB subnet(s) 1022 can transmit the request to app subnet(s) 1026 contained in the control plane app tier 1024. If the request is validated and requires a call to public Internet 1054, the call to public Internet 1054 may be transmitted to the NAT gateway 1038, which can make the call to public Internet 1054. Metadata that may be desired to be stored by the request can be stored in the DB subnet(s) 1030.

In some examples, the data plane mirror app tier 1040 can facilitate direct communication between the control plane VCN 1016 and the data plane VCN 1018. For example, changes, updates, or other suitable modifications to the configuration may be desired to be applied to the resources contained in the data plane VCN 1018. Via a VNIC 1042, the control plane VCN 1016 can directly communicate with and can thereby execute the changes, updates, or other suitable modifications to configuration to resources contained in the data plane VCN 1018.

In some embodiments, the control plane VCN 1016 and the data plane VCN 1018 can be contained in the service tenancy 1019. In this case, the user or the customer of the system may not own or operate either the control plane VCN 1016 or the data plane VCN 1018. Instead, the IaaS provider may own or operate the control plane VCN 1016 and the data plane VCN 1018, both of which may be contained in the service tenancy 1019. This embodiment can enable the isolation of networks that may prevent users or customers from interacting with other users' or other customers' resources. Also, this embodiment may allow users or customers of the system to store databases privately without needing to rely on public Internet 1054, which may not have a desired level of threat prevention for storage.

In other embodiments, the LB subnet(s) 1022 contained in the control plane VCN 1016 can be configured to receive a signal from the service gateway 1036. In this embodiment, the control plane VCN 1016 and the data plane VCN 1018 may be configured to be called by a customer of the IaaS provider without calling public Internet 1054. Customers of the IaaS provider may desire this embodiment since the database(s) that the customers use may be controlled by the IaaS provider and may be stored on the service tenancy 1019, which may be isolated from public Internet 1054.

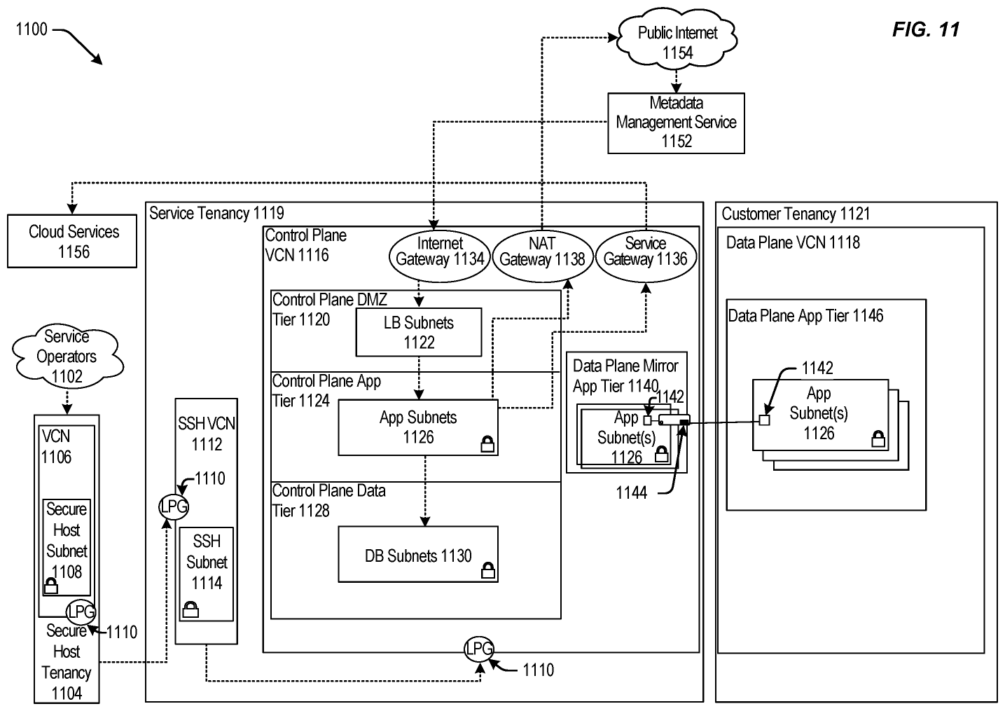

FIG. 11 is a block diagram 1100 illustrating another example pattern of an IaaS architecture, according to at least one embodiment. Service operators 1102 (e.g., service operators 1002 of FIG. 10) can be communicatively coupled to a secure host tenancy 1104 (e.g., the secure host tenancy 1004 of FIG. 10) that can include a virtual cloud network (VCN) 1106 (e.g., the VCN 1006 of FIG. 10) and a secure host subnet 1108 (e.g., the secure host subnet 1008 of FIG. 10). The VCN 1106 can include a local peering gateway (LPG) 1110 (e.g., the LPG 1010 of FIG. 10) that can be communicatively coupled to a secure shell (SSH) VCN 1112 (e.g., the SSH VCN 1012 of FIG. 10) via an LPG 1010 contained in the SSH VCN 1112. The SSH VCN 1112 can include an SSH subnet 1114 (e.g., the SSH subnet 1014 of FIG. 10), and the SSH VCN 1112 can be communicatively coupled to a control plane VCN 1116 (e.g., the control plane VCN 1016 of FIG. 10) via an LPG 1110 contained in the control plane VCN 1116. The control plane VCN 1116 can be contained in a service tenancy 1119 (e.g., the service tenancy 1019 of FIG. 10), and the data plane VCN 1118 (e.g., the data plane VCN 1018 of FIG. 10) can be contained in a customer tenancy 1121 that may be owned or operated by users, or customers, of the system.

The control plane VCN 1116 can include a control plane DMZ tier 1120 (e.g., the control plane DMZ tier 1020 of FIG. 10) that can include LB subnet(s) 1122 (e.g., LB subnet(s) 1022 of FIG. 10), a control plane app tier 1124 (e.g., the control plane app tier 1024 of FIG. 10) that can include app subnet(s) 1126 (e.g., app subnet(s) 1026 of FIG. 10), a control plane data tier 1128 (e.g., the control plane data tier 1028 of FIG. 10) that can include database (DB) subnet(s) 1130 (e.g., similar to DB subnet(s) 1030 of FIG. 10). The LB subnet(s) 1122 contained in the control plane DMZ tier 1120 can be communicatively coupled to the app subnet(s) 1126 contained in the control plane app tier 1124 and an Internet gateway 1134 (e.g., the Internet gateway 1034 of FIG. 10) that can be contained in the control plane VCN 1116, and the app subnet(s) 1126 can be communicatively coupled to the DB subnet(s) 1130 contained in the control plane data tier 1128 and a service gateway 1136 (e.g., the service gateway 1036 of FIG. 10) and a network address translation (NAT) gateway 1138 (e.g., the NAT gateway 1038 of FIG. 10). The control plane VCN 1116 can include the service gateway 1136 and the NAT gateway 1138.

The control plane VCN 1116 can include a data plane mirror app tier 1140 (e.g., the data plane mirror app tier 1040 of FIG. 10) that can include app subnet(s) 1126. The app subnet(s) 1126 contained in the data plane mirror app tier 1140 can include a virtual network interface controller (VNIC) 1142 (e.g., the VNIC of 1042) that can execute a compute instance 1144 (e.g., similar to the compute instance 1044 of FIG. 10). The compute instance 1144 can facilitate communication between the app subnet(s) 1126 of the data plane mirror app tier 1140 and the app subnet(s) 1126 that can be contained in a data plane app tier 1146 (e.g., the data plane app tier 1046 of FIG. 10) via the VNIC 1142 contained in the data plane mirror app tier 1140 and the VNIC 1142 contained in the data plane app tier 1146.

The Internet gateway 1134 contained in the control plane VCN 1116 can be communicatively coupled to a metadata management service 1152 (e.g., the metadata management service 1052 of FIG. 10) that can be communicatively coupled to public Internet 1154 (e.g., public Internet 1054 of FIG. 10). Public Internet 1154 can be communicatively coupled to the NAT gateway 1138 contained in the control plane VCN 1116. The service gateway 1136 contained in the control plane VCN 1116 can be communicatively coupled to cloud services 1156 (e.g., cloud services 1056 of FIG. 10).

In some examples, the data plane VCN 1118 can be contained in the customer tenancy 1121. In this case, the IaaS provider may provide the control plane VCN 1116 for each customer, and the IaaS provider may, for each customer, set up a unique compute instance 1144 that is contained in the service tenancy 1119. Each compute instance 1144 may allow communication between the control plane VCN 1116, contained in the service tenancy 1119, and the data plane VCN 1118, which is contained in the customer tenancy 1121. The compute instance 1144 may allow resources that are provisioned in the control plane VCN 1116 that is contained in the service tenancy 1119, to be deployed or otherwise used in the data plane VCN 1118 that is contained in the customer tenancy 1121.

In other examples, the customer of the IaaS provider may have databases that live in the customer tenancy 1121. In this example, the control plane VCN 1116 can include the data plane mirror app tier 1140 that can include app subnet(s) 1126. The data plane mirror app tier 1140 can reside in the data plane VCN 1118, but the data plane mirror app tier 1140 may not live in the data plane VCN 1118. That is, the data plane mirror app tier 1140 may have access to the customer tenancy 1121, but the data plane mirror app tier 1140 may not exist in the data plane VCN 1118 or be owned or operated by the customer of the IaaS provider. The data plane mirror app tier 1140 may be configured to make calls to the data plane VCN 1118 but may not be configured to make calls to any entity contained in the control plane VCN 1116. The customer may desire to deploy or otherwise use resources in the data plane VCN 1118 that are provisioned in the control plane VCN 1116, and the data plane mirror app tier 1140 can facilitate the desired deployment, or other usage of resources, of the customer.

In some embodiments, the customer of the IaaS provider can apply filters to the data plane VCN 1118. In this embodiment, the customer can determine what the data plane VCN 1118 can access, and the customer may restrict access to public Internet 1154 from the data plane VCN 1118. The IaaS provider may not be able to apply filters or otherwise control access of the data plane VCN 1118 to any outside networks or databases. Applying filters and controls by the customer onto the data plane VCN 1118, contained in the customer tenancy 1121, can help isolate the data plane VCN 1118 from other customers and from public Internet 1154.

In some embodiments, cloud services 1156 can be called by the service gateway 1136 to access services that may not exist on public Internet 1154, on the control plane VCN 1116, or on the data plane VCN 1118. The connection between cloud services 1156 and the control plane VCN 1116 or the data plane VCN 1118 may not be live or continuous. Cloud services 1156 may exist on a different network owned or operated by the IaaS provider. Cloud services 1156 may be configured to receive calls from the service gateway 1136 and may be configured to not receive calls from public Internet 1154. Some cloud services 1156 may be isolated from other cloud services 1156, and the control plane VCN 1116 may be isolated from cloud services 1156 that may not be in the same region as the control plane VCN 1116. For example, the control plane VCN 1116 may be located in “Region 1,” and cloud service “Deployment 10,” may be located in Region 1 and in “Region 2.” If a call to Deployment 10 is made by the service gateway 1136 contained in the control plane VCN 1116 located in Region 1, the call may be transmitted to Deployment 10 in Region 1. In this example, the control plane VCN 1116, or Deployment 10 in Region 1, may not be communicatively coupled to, or otherwise in communication with, Deployment 10 in Region 2.

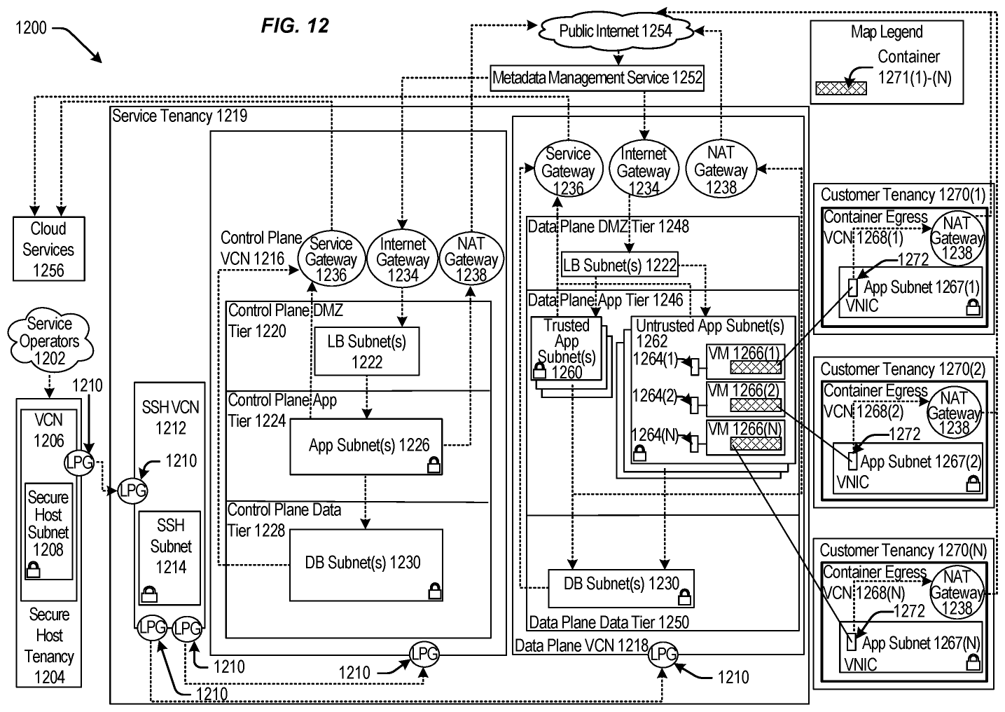

FIG. 12 is a block diagram 1200 illustrating another example pattern of an IaaS architecture, according to at least one embodiment. Service operators 1202 (e.g., service operators 1002 of FIG. 10) can be communicatively coupled to a secure host tenancy 1204 (e.g., the secure host tenancy 1004 of FIG. 10) that can include a virtual cloud network (VCN) 1206 (e.g., the VCN 1006 of FIG. 10) and a secure host subnet 1208 (e.g., the secure host subnet 1008 of FIG. 10). The VCN 1206 can include an LPG 1210 (e.g., the LPG 1010 of FIG. 10) that can be communicatively coupled to an SSH VCN 1212 (e.g., the SSH VCN 1012 of FIG. 10) via an LPG 1210 contained in the SSH VCN 1212. The SSH VCN 1212 can include an SSH subnet 1214 (e.g., the SSH subnet 1014 of FIG. 10), and the SSH VCN 1212 can be communicatively coupled to a control plane VCN 1216 (e.g., the control plane VCN 1016 of FIG. 10) via an LPG 1210 contained in the control plane VCN 1216 and to a data plane VCN 1218 (e.g., the data plane 1018 of FIG. 10) via an LPG 1210 contained in the data plane VCN 1218. The control plane VCN 1216 and the data plane VCN 1218 can be contained in a service tenancy 1219 (e.g., the service tenancy 1019 of FIG. 10).

The control plane VCN 1216 can include a control plane DMZ tier 1220 (e.g., the control plane DMZ tier 1020 of FIG. 10) that can include load balancer (LB) subnet(s) 1222 (e.g., LB subnet(s) 1022 of FIG. 10), a control plane app tier 1224 (e.g., the control plane app tier 1024 of FIG. 10) that can include app subnet(s) 1226 (e.g., similar to app subnet(s) 1026 of FIG. 10), a control plane data tier 1228 (e.g., the control plane data tier 1028 of FIG. 10) that can include DB subnet(s) 1230. The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 1034 of FIG. 10) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 10) and a network address translation (NAT) gateway 1238 (e.g., the NAT gateway 1038 of FIG. 10). The control plane VCN 1216 can include the service gateway 1236 and the NAT gateway 1238.

The data plane VCN 1218 can include a data plane app tier 1246 (e.g., the data plane app tier 1046 of FIG. 10), a data plane DMZ tier 1248 (e.g., the data plane DMZ tier 1048 of FIG. 10), and a data plane data tier 1250 (e.g., the data plane data tier 1050 of FIG. 10). The data plane DMZ tier 1248 can include LB subnet(s) 1222 that can be communicatively coupled to trusted app subnet(s) 1260 and untrusted app subnet(s) 1262 of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include one or more primary VNICs 1264(1)-(N) that can be communicatively coupled to tenant virtual machines (VMs) 1266(1)-(N). Each tenant VM 1266(1)-(N) can be communicatively coupled to a respective app subnet 1267(1)-(N) that can be contained in respective container egress VCNs 1268(1)-(N) that can be contained in respective customer tenancies 1270(1)-(N). Respective secondary VNICs 1272(1)-(N) can facilitate communication between the untrusted app subnet(s) 1262 contained in the data plane VCN 1218 and the app subnet contained in the container egress VCNs 1268(1)-(N). Each container egress VCNs 1268(1)-(N) can include a NAT gateway 1238 that can be communicatively coupled to public Internet 1254 (e.g., public Internet 1054 of FIG. 10).

The Internet gateway 1234 contained in the control plane VCN 1216 and contained in the data plane VCN 1218 can be communicatively coupled to a metadata management service 1252 (e.g., the metadata management system 1052 of FIG. 10) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some embodiments, the data plane VCN 1218 can be integrated with customer tenancies 1270. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1246. Code to run the function may be executed in the VMs 1266(1)-(N), and the code may not be configured to run anywhere else on the data plane VCN 1218. Each VM 1266(1)-(N) may be connected to one customer tenancy 1270. Respective containers 1271(1)-(N) contained in the VMs 1266(1)-(N) may be configured to run the code. In this case, there can be a dual isolation (e.g., the containers 1271(1)-(N) running code, where the containers 1271(1)-(N) may be contained in at least the VM 1266(1)-(N) that are contained in the untrusted app subnet(s) 1262), which may help prevent incorrect or otherwise undesirable code from damaging the network of the IaaS provider or from damaging a network of a different customer. The containers 1271(1)-(N) may be communicatively coupled to the customer tenancy 1270 and may be configured to transmit or receive data from the customer tenancy 1270. The containers 1271(1)-(N) may not be configured to transmit or receive data from any other entity in the data plane VCN 1218. Upon completion of running the code, the IaaS provider may kill or otherwise dispose of the containers 1271(1)-(N).

In some embodiments, the trusted app subnet(s) 1260 may run code that may be owned or operated by the IaaS provider. In this embodiment, the trusted app subnet(s) 1260 may be communicatively coupled to the DB subnet(s) 1230 and be configured to execute CRUD operations in the DB subnet(s) 1230. The untrusted app subnet(s) 1262 may be communicatively coupled to the DB subnet(s) 1230, but in this embodiment, the untrusted app subnet(s) may be configured to execute read operations in the DB subnet(s) 1230. The containers 1271(1)-(N) that can be contained in the VM 1266(1)-(N) of each customer and that may run code from the customer may not be communicatively coupled with the DB subnet(s) 1230.

In other embodiments, the control plane VCN 1216 and the data plane VCN 1218 may not be directly communicatively coupled. In this embodiment, there may be no direct communication between the control plane VCN 1216 and the data plane VCN 1218. However, communication can occur indirectly through at least one method. An LPG 1210 may be established by the IaaS provider that can facilitate communication between the control plane VCN 1216 and the data plane VCN 1218. In another example, the control plane VCN 1216 or the data plane VCN 1218 can make a call to cloud services 1256 via the service gateway 1236. For example, a call to cloud services 1256 from the control plane VCN 1216 can include a request for a service that can communicate with the data plane VCN 1218.

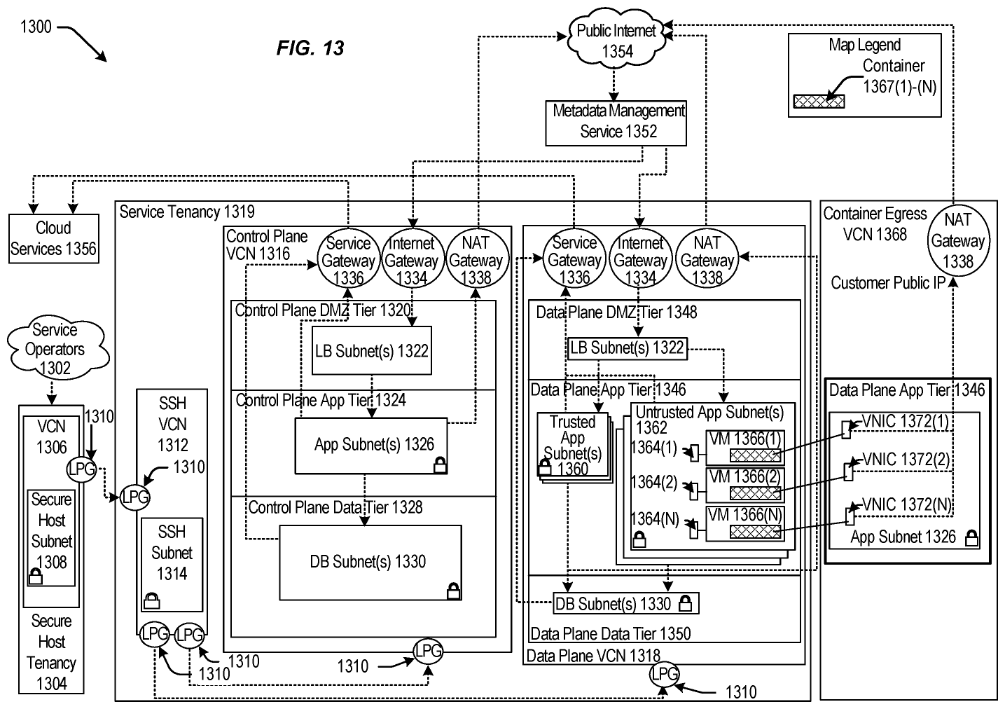

FIG. 13 is a block diagram 1300 illustrating another example pattern of an IaaS architecture, according to at least one embodiment. Service operators 1302 (e.g., service operators 1002 of FIG. 10) can be communicatively coupled to a secure host tenancy 1304 (e.g., the secure host tenancy 1004 of FIG. 10) that can include a virtual cloud network (VCN) 1306 (e.g., the VCN 1006 of FIG. 10) and a secure host subnet 1308 (e.g., the secure host subnet 1008 of FIG. 10). The VCN 1306 can include an LPG 1310 (e.g., the LPG 1010 of FIG. 10) that can be communicatively coupled to an SSH VCN 1312 (e.g., the SSH VCN 1012 of FIG. 10) via an LPG 1310 contained in the SSH VCN 1312. The SSH VCN 1312 can include an SSH subnet 1314 (e.g., the SSH subnet 1014 of FIG. 10), and the SSH VCN 1312 can be communicatively coupled to a control plane VCN 1316 (e.g., the control plane VCN 1016 of FIG. 10) via an LPG 1310 contained in the control plane VCN 1316 and to a data plane VCN 1318 (e.g., the data plane 1018 of FIG. 10) via an LPG 1310 contained in the data plane VCN 1318. The control plane VCN 1316 and the data plane VCN 1318 can be contained in a service tenancy 1319 (e.g., the service tenancy 1019 of FIG. 10).

The control plane VCN 1316 can include a control plane DMZ tier 1320 (e.g., the control plane DMZ tier 1020 of FIG. 10) that can include LB subnet(s) 1322 (e.g., LB subnet(s) 1022 of FIG. 10), a control plane app tier 1324 (e.g., the control plane app tier 1024 of FIG. 10) that can include app subnet(s) 1326 (e.g., app subnet(s) 1026 of FIG. 10), a control plane data tier 1328 (e.g., the control plane data tier 1028 of FIG. 10) that can include DB subnet(s) 1330 (e.g., DB subnet(s) 1230 of FIG. 12). The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1034 of FIG. 10) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 10) and a network address translation (NAT) gateway 1338 (e.g., the NAT gateway 1038 of FIG. 10). The control plane VCN 1316 can include the service gateway 1336 and the NAT gateway 1338.

The data plane VCN 1318 can include a data plane app tier 1346 (e.g., the data plane app tier 1046 of FIG. 10), a data plane DMZ tier 1348 (e.g., the data plane DMZ tier 1048 of FIG. 10), and a data plane data tier 1350 (e.g., the data plane data tier 1050 of FIG. 10). The data plane DMZ tier 1348 can include LB subnet(s) 1322 that can be communicatively coupled to trusted app subnet(s) 1360 (e.g., trusted app subnet(s) 1260 of FIG. 12) and untrusted app subnet(s) 1362 (e.g., untrusted app subnet(s) 1262 of FIG. 12) of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include primary VNICs 1364(1)-(N) that can be communicatively coupled to tenant virtual machines (VMs) 1366(1)-(N) residing within the untrusted app subnet(s) 1362. Each tenant VM 1366(1)-(N) can run code in a respective container 1367(1)-(N) and be communicatively coupled to an app subnet 1326 that can be contained in a data plane app tier 1346 that can be contained in a container egress VCN 1368. Respective secondary VNICs 1372(1)-(N) can facilitate communication between the untrusted app subnet(s) 1362 contained in the data plane VCN 1318 and the app subnet contained in the container egress VCN 1368. The container egress VCN can include a NAT gateway 1338 that can be communicatively coupled to public Internet 1354 (e.g., public Internet 1054 of FIG. 10).

The Internet gateway 1334 contained in the control plane VCN 1316 and contained in the data plane VCN 1318 can be communicatively coupled to a metadata management service 1352 (e.g., the metadata management system 1052 of FIG. 10) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some examples, the pattern illustrated by the architecture of block diagram 1300 of FIG. 13 may be considered an exception to the pattern illustrated by the architecture of block diagram 1200 of FIG. 12 and may be desirable for a customer of the IaaS provider if the IaaS provider cannot directly communicate with the customer (e.g., a disconnected region). The respective containers 1367(1)-(N) that are contained in the VMs 1366(1)-(N) for each customer can be accessed in real-time by the customer. The containers 1367(1)-(N) may be configured to make calls to respective secondary VNICs 1372(1)-(N) contained in app subnet(s) 1326 of the data plane app tier 1346 that can be contained in the container egress VCN 1368. The secondary VNICs 1372(1)-(N) can transmit the calls to the NAT gateway 1338 that may transmit the calls to public Internet 1354. In this example, the containers 1367(1)-(N) that can be accessed in real-time by the customer can be isolated from the control plane VCN 1316 and can be isolated from other entities contained in the data plane VCN 1318. The containers 1367(1)-(N) may also be isolated from resources from other customers.

In other examples, the customer can use the containers 1367(1)-(N) to call cloud services 1356. In this example, the customer may run code in the containers 1367(1)-(N) that requests a service from cloud services 1356. The containers 1367(1)-(N) can transmit this request to the secondary VNICs 1372(1)-(N) that can transmit the request to the NAT gateway that can transmit the request to public Internet 1354. Public Internet 1354 can transmit the request to LB subnet(s) 1322 contained in the control plane VCN 1316 via the Internet gateway 1334. In response to determining the request is valid, the LB subnet(s) can transmit the request to app subnet(s) 1326 that can transmit the request to cloud services 1356 via the service gateway 1336.

It should be appreciated that IaaS architectures 1000, 1100, 1200, 1300 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

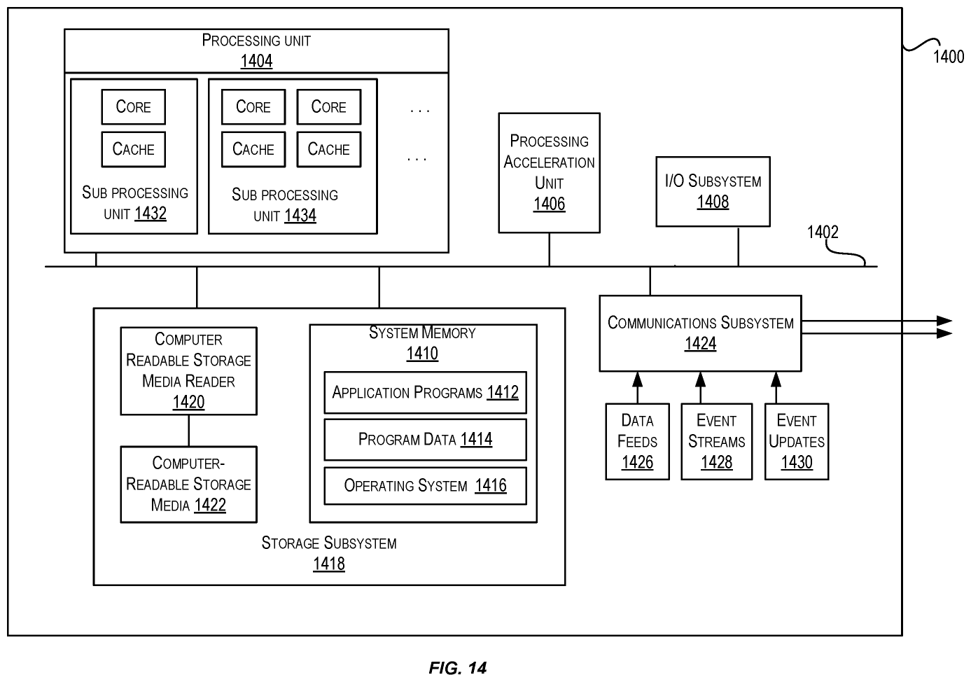

FIG. 14 illustrates an example computer system 1400, in which various embodiments may be implemented. The system 1400 may be used to implement any of the computer systems described above. As shown in the figure, computer system 1400 includes a processing unit 1404 that communicates with a number of peripheral subsystems via a bus subsystem 1402. These peripheral subsystems may include a processing acceleration unit 1406, an I/O subsystem 1408, a storage subsystem 1418 and a communications subsystem 1424. Storage subsystem 1418 includes tangible computer-readable storage media 1422 and a system memory 1410.

Bus subsystem 1402 provides a mechanism for letting the various components and subsystems of computer system 1400 communicate with each other as intended. Although bus subsystem 1402 is shown schematically as a single bus, alternative embodiments of the bus subsystem may utilize multiple buses. Bus subsystem 1402 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1404, which can be implemented as one or more integrated circuits (e.g., a conventional microprocessor or microcontroller), controls the operation of computer system 1400. One or more processors may be included in processing unit 1404. These processors may include single core or multicore processors. In certain embodiments, processing unit 1404 may be implemented as one or more independent processing units 1432 and/or 1434 with single or multicore processors included in each processing unit. In other embodiments, processing unit 1404 may also be implemented as a quad-core processing unit formed by integrating two dual-core processors into a single chip.

In various embodiments, processing unit 1404 can execute a variety of programs in response to program code and can maintain multiple concurrently executing programs or processes. At any given time, some or all of the program code to be executed can be resident in processor(s) 1404 and/or in storage subsystem 1418. Through suitable programming, processor(s) 1404 can provide various functionalities described above. Computer system 1400 may additionally include a processing acceleration unit 1406, which can include a digital signal processor (DSP), a special-purpose processor, and/or the like.

I/O subsystem 1408 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1400 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1400 may comprise a storage subsystem 1418 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1404 provide the functionality described above. Storage subsystem 1418 may also provide a repository for storing data used in accordance with the present disclosure.

As depicted in the example in FIG. 14, storage subsystem 1418 can include various components including a system memory 1410, computer-readable storage media 1422, and a computer readable storage media reader 1420. System memory 1410 may store program instructions that are loadable and executable by processing unit 1404. System memory 1410 may also store data that is used during the execution of the instructions and/or data that is generated during the execution of the program instructions. Various different kinds of programs may be loaded into system memory 1410 including but not limited to client applications, Web browsers, mid-tier applications, relational database management systems (RDBMS), virtual machines, containers, etc.

System memory 1410 may also store an operating system 1416. Examples of operating system 1416 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1400 executes one or more virtual machines, the virtual machines along with their guest operating systems (GOSs) may be loaded into system memory 1410 and executed by one or more processors or cores of processing unit 1404.

System memory 1410 can come in different configurations depending upon the type of computer system 1400. For example, system memory 1410 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1410 may include a basic input/output system (BIOS) containing basic routines that help to transfer information between elements within computer system 1400, such as during start-up.

Computer-readable storage media 1422 may represent remote, local, fixed, and/or removable storage devices plus storage media for temporarily and/or more permanently containing, storing, computer-readable information for use by computer system 1400 including instructions executable by processing unit 1404 of computer system 1400.

Computer-readable storage media 1422 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1422 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1422 may include, but is not limited to, Zip® drives, flash memory cards, universal serial bus (USB) flash drives, secure digital (SD) cards, DVD disks, digital video tape, and the like. Computer-readable storage media 1422 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1400.

Machine-readable instructions executable by one or more processors or cores of processing unit 1404 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1424 provides an interface to other computer systems and networks. Communications subsystem 1424 serves as an interface for receiving data from and transmitting data to other systems from computer system 1400. For example, communications subsystem 1424 may enable computer system 1400 to connect to one or more devices via the Internet. In some embodiments communications subsystem 1424 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1424 can provide wired network connectivity (e.g., Ethernet) in addition to or instead of a wireless interface.

In some embodiments, communications subsystem 1424 may also receive input communication in the form of structured and/or unstructured data feeds 1426, event streams 1428, event updates 1430, and the like on behalf of one or more users who may use computer system 1400.

By way of example, communications subsystem 1424 may be configured to receive data feeds 1426 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1424 may also be configured to receive data in the form of continuous data streams, which may include event streams 1428 of real-time events and/or event updates 1430, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1424 may also be configured to output the structured and/or unstructured data feeds 1426, event streams 1428, event updates 1430, and the like to one or more databases that may be in communication with one or more streaming data source computers coupled to computer system 1400.

Computer system 1400 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1400 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
monitoring, by a computing process executing at a host machine, a boot volume associated with a hypervisor, the computing process being deployed to the host machine as part of the hypervisor;
executing, by the computing process, one or more write requests to the boot volume associated with the hypervisor;
detecting, by the computing process, that the boot volume is operating in a read-only mode based at least in part on receiving one or more error codes, the one or more error codes being received in response to at least one of the one or more write requests;
verifying, by the computing process, that the boot volume associated with the hypervisor is operating in the read-only mode; and
responsive to verifying that the boot volume associated with the hypervisor is operating in the read-only mode, executing, by the computing process, operations for rebooting the hypervisor.

2. The computer-implemented method of claim 1, wherein the one or more error codes comprises at least one of 1) an Error—Input/Output (EIO) error code or 2) an Error—Read-Only File System (EROFS) error code.

3. The computer-implemented method of claim 1, wherein the computing process is a first computing process executing at a first host machine, the first computing process being separate from a second computing process executing at a second host machine, and wherein the second computing process is configured to monitor a corresponding boot volume of a respective hypervisor executing at the second host machine.

4. The computer-implemented method of claim 1, further comprising:
responsive to verifying that the boot volume associated with the hypervisor is operating in the read-only mode, transmitting, by the computing process to at least one logging service, logging data indicating the boot volume associated with the hypervisor is operating in the read-only mode, wherein the logging data is transmitted utilizing Domain Name Server (DNS) data, a Transport Layer Security (TLS) certificate, and a Public Key Infrastructure (PKI) certificate that are stored in local memory of the host machine.

5. The computer-implemented method of claim 1, further comprising:
responsive to verifying that the boot volume associated with the hypervisor is operating in the read-only mode, transmitting, by the computing process to a baseboard management controller of the host machine, one or more console messages indicating the boot volume associated with the hypervisor is operating in the read-only mode, wherein the baseboard management controller persists the one or more console messages in local memory at the host machine.

6. The computer-implemented method of claim 1, wherein executing the operations for rebooting the hypervisor causes the hypervisor to enter a wait-for-recovery mode during which a boot loop is executed, wherein executing the boot loop causes the hypervisor to wait for a network dependency on the boot volume to be met prior to attempting to boot from the boot volume.

7. The computer-implemented method of claim 1, wherein the boot volume associated with the hypervisor is remote with respect to the host machine and accessible via one or more networks.

8. A watchdog daemon associated with a hypervisor of a computing device, the computing device comprising:
one or more processors; and
one or more memories storing computer-executable instructions that, when executed by the one or more processors, cause the watchdog daemon to:
transmit, via a network, a first write request corresponding to a boot volume associated with the hypervisor of the computing device;
detect a first error code corresponding to the first write request, the first error code indicating that the boot volume associated with the hypervisor is operating in a read-only mode;
in response to detecting the first error code, transmit a second write request corresponding to the boot volume associated with the hypervisor of the computing device; and
in response to detecting at least the first error code, execute one or more operations associated with rebooting the hypervisor.

9. The watchdog daemon of claim 8, wherein the watchdog daemon was deployed to the computing device as part of the hypervisor.

10. The watchdog daemon of claim 8, wherein the watchdog daemon operates as a background process at the computing device, and wherein execution of the watchdog daemon is initiated by a system manager of an operating system of the computing device.

11. The watchdog daemon of claim 8, wherein the watchdog daemon is configured to detect, based at least in part on detecting the first error code, at least one of: expiration of a Small Computer System Interface (SCSI) command timer, expiration of an Internet Small Computer System Interface (iSCSI) replacement timer, or an iSCSI session logout.

12. The watchdog daemon of claim 8, wherein a number of tasks, memory usage, and disk storage corresponding to the watchdog daemon is limited.

13. The watchdog daemon of claim 8, wherein the watchdog daemon is restricted from rebooting the hypervisor unless the hypervisor has been executing for a period of time that exceeds a threshold period of time.

14. A non-transitory computer-readable medium comprising one or more memories storing computer-executable instructions corresponding to a watchdog daemon that, when executed by one or more processors of a computing device, causes the watchdog daemon to:
monitor access to a boot volume associated with a hypervisor executing at the computing device;
transmit, via one or more networks, periodic requests to the boot volume associated with the hypervisor;
receive a response to a request of the periodic requests, the response indicating that the boot volume associated with the hypervisor is in a read-only mode; and
perform one or more remedial actions based at least in part on receiving the response indicating that the boot volume associated with the hypervisor is in the read-only mode.

15. The non-transitory computer-readable medium of claim 14, wherein the one or more remedial actions comprise transmitting logging data to one or more logging services, wherein transmitting the logging data to the one or more logging services causes a status corresponding to the boot volume to be presented at a user interface, the status indicating the boot volume is operating in the read-only mode.

16. The non-transitory computer-readable medium of claim 14, wherein the computer-executable instructions corresponding to the watchdog daemon further causes the watchdog daemon to:
receive a second response to a second request of the periodic requests, the second response indicating that the boot volume associated with the hypervisor is in a read-only mode, wherein the one or more remedial actions are preformed further based at least in part on receiving the second response indicating that the boot volume associated with the hypervisor is in the read-only mode.

17. The non-transitory computer-readable medium of claim 14, wherein executing the computer-executable instructions corresponding to the watchdog daemon further causes the watchdog daemon to:
identify a time at which the hypervisor was last booted; and
responsive to determining that a threshold time has elapsed since the time at which the hypervisor was last booted, reboot the hypervisor as part of performing the one or more remedial actions.

18. The non-transitory computer-readable medium of claim 17, wherein executing the computer-executable instructions corresponding to the watchdog daemon further causes the watchdog daemon to print a message to a console prior to rebooting the hypervisor.

19. The non-transitory computer-readable medium of claim 14, wherein the response comprises an input/output error or a read-only filesystem error, and wherein the input/output error or the read-only filesystem error provide an indication that the boot volume associated with the hypervisor is in the read-only mode.

20. The non-transitory computer-readable medium of claim 14, wherein executing the computer-executable instructions corresponding to the watchdog daemon further causes the watchdog daemon to transmit one or more metrics to one or more logging services prior to rebooting the hypervisor.
